(19) United States
(12) Patent Application Publication
(10) Pub. No.: US 2009/0223217 A1
(43) Pub. Date: Sep. 10, 2009

(54) METHOD AND APPARATUS FOR USING EXPLOSIVES FOR GENERATING POWER

(76) Inventor: Enock N. Segawa, Rockford, MI (US)

Correspondence Address: Enock Segawa, P.O. BOX 3472, Grand Rapids, MI, 49501, US

(21) Appl. No.: 12/399,423

(22) Filed: Mar. 6, 2009

Related U.S. Application Data
(60) Provisional application No. 61/034,704, filed on Mar. 7, 2008.

(51) Int. Cl. F15B 21/12

(52) U.S. Cl. 60/532

(57) ABSTRACT

A method and apparatus for pressurizing a fluid within a combustion chamber and storing that pressurized fluid in a reservoir for later use to power a motor or do other work. The invention includes the apparatus to achieve the method. The method comprises the steps of determining and selecting the particular material or compound to be used as a fuel; one the type of fuel is selected the method involves selecting the reagents necessary to create the fuel; storing the reagents and raw materials; reacting the reagents and raw materials together; conditioning the output from the reacting process; purifying, separating and reusing the reagents from the finished fuel produced by the reacting process; conditioning the material; delivering the material or compound to the combustion chamber; combusting the fuel to produce a high pressure gas; recycling waste of the combustion; and storing the high pressure gas in a vessel.

### CROSS REFERENCE TO RELATED APPLICATIONS

This application claims priority from U.S. Provisional Patent Application Ser. No. 61/034,704 filed Mar. 7, 2008, the contents of which are incorporated herein by reference.

### BACKGROUND OF THE INVENTION

### STATEMENT REGARDING FEDERALLY SPONSORED RESEARCH OR DEVELOPMENT

This invention was not conceived or developed using any funding provided by the United States government, it agencies, or other governmental agency.

1. Field of the Invention

The present invention relates to a method and apparatus for power generation, and particularly to a method and apparatus for pressurizing a vessel.

2. Description of the Related Art

The growing increase in the global demand for energy has prompted many inventors to try to come up with better ways of improving fuel economy. A great deal of effort in this field has been devoted to the improvement of the internal combustion engine in several ways including combining it with electric motors. Such hybrid systems sometimes increase efficiency by capturing braking energy and using it to recharge batteries on the vehicle.

Another scheme that has been tried to operate vehicles is to charge air tanks with compressed air and use it to operate a pneumatic motor in the vehicle. The disadvantage of this concept is that compressed air has a low energy density which limits the total distance that can be covered on one full tank of air. Another concept being considered by auto manufactures to increase efficiency is to reduce the weight of the vehicle through the use of light weight materials. Eliminating conventional rigid materials compromises the safety of the automobile occupant(s), not to mention that light weight materials e.g. aluminum, carbon fiber etc, tend to increase the overall cost of the vehicle.

The concepts briefly described above seem to be wanting in one way or another and the usual efficiency gains seem to be between 5% and 20%. These efficiency gains are too low to justify the technology and equipment/capital invested; hence the final cost of a hybrid system is very high. Therefore there exists a need to increase the efficiency of vehicle engines in an economic manner while minimizing harmful emissions. Therefore disclosed herein is a method and apparatus to address the above mentioned problems.

The inventor is not aware of any prior art teaching safely using energetic materials such as explosive for the constructive purposes of generating power. This is due in large part to the extremely high rate of energy released by explosive and the inability of the artisan to attenuate or safely control the explosive force. The present invention solves all the problems surrounding the use of explosives to generate power by (i) producing only small amounts and stabilizing/desensitizing them in real time (ii) keeping the material below critical mass until just before ignition, and (iii) using highly stable forms of explosive compounds. Details of the invention are provided below.

### SUMMARY OF THE INVENTION

The invention discloses the process of using chemical compounds that are capable of explosively releasing energy. The invention provides a method using certain explosive compounds to produce high pressure gases which is then stored to drive motors or provide power to other forms of engines. The invention also provides a method for producing the compounds as needed on a vehicle to provide a constant source of high pressure gases to be used to power a motor such as an engine. The method also includes steps for attenuating or stabilizing the explosives/energetic material to a point where their stability hence safety exceeds that of Hydrocarbon fuels

Explosive compounds have been used to produce work. The internal combustion engine is such a device where a relatively stable product is compressed and ignited in a closed space. The ignition and combustion of the fuel produces an expanding gas that drives the piston of the motor to produce the work. The most widely used fuel today is gasoline and diesel fuel (HCFs). These fuels are mixed with oxygen, thereby making an explosive compound with a relatively slow combustion rate. From a practical stand point, there is basically no difference between the two except explosives possess oxygen needed for combustion while HCFs are not mixed with oxygen until just before combustion. The brisance, shockwave etc, that follows combustion of chemical explosives which is absent with the HCF combustion is probably due to the supersonic flame propagation rates through the explosives/energetic materials as compared to the subsonic speed that the flame propagates through HCF/oxygen mixtures.

The present invention addresses those problems by providing a means for attenuating and or stabilizing the chemical explosives while at the same time providing methods for easy synthesis of the explosive chemicals, by taking advantage of readily available reagents and using them on board a vehicle to synthesize the chemical explosives. These compounds may be used as the sole source of energy or in a hybrid or supplemental manner to increase the efficiency hence mileage of the above mentioned present day engines.

One of the objects of the present invention is to provide a means for increasing the fuel economy of current engines. Another object is to provide a means for an auxiliary/supplemental gas pressure generator which is retrofitable to existing engines or pneumatic systems or a combination thereof. Another object is to provide a means for the on-site production of fuel. Yet another object of the invention is to provide a means for making use of compounds that are waste products of other processes normally discarded to create energetic materials to be safely used to generate power. Yet another object of the invention is to provide a means for a hybrid engine with at least one chamber running on HCF and at least one chamber running on compressed gases. Still another object of this invention is to provide a means for eliminating the compression stroke in a conventional HCF engine thereby increasing the efficiency of the engine. It is still another object of this invention to reduce carbon emissions produced by internal combustion engines and ultimately reduce the amount of green house gases dumped to atmosphere. Yet another object of this invention is to provide a use for glycerin by-product. It is yet another object to provide an engine with the any combination of the above objects. Other objects will become apparent from a careful study of the present invention and the corresponding embodiments.

One form of the invention includes a method for pressurizing a fluid reservoir, comprising the steps of reacting raw components in a reaction chamber assembly to produce an explosive compound; diluting the explosive compound exiting the reaction chamber assembly; injecting the diluted explosive compound into a combustion chamber; igniting the diluted explosive compound in the combustion chamber causing the diluted explosive compound to produce a rapidly expanding gas; and venting the rapidly expanding gas to a pressure vessel connected to the combustion chamber through at least one one-way valve system. Other forms of the invention further include steps for purifying the explosive compound from the raw components exiting the reaction chamber prior to the step of igniting as well as separately storing the raw components in individual containers adjacent the reaction chamber assembly. Further variations of the invention include passing the raw components through at least one micro-channel reactor to effectuate the mixing and reaction of the compounds.

Another form of the invention includes the apparatus for pressurizing a fluid reservoir, comprising a fuel processor assembly; a combustion assembly having an inlet in fluid communication with the fuel processor assembly; an ignition assembly disposed within the combustion assembly; a pressure vessel assembly in fluid communication with an outlet of the combustion assembly via a conduit, the conduit including a valve assembly permitting flow of pressurized fluid in one direction from the combustion assembly to the storage container; and a pneumatically operated device in fluid communication with the pressure vessel through a metered conduit. Modifications or variations of the invention include a plurality of reagent containers each containing at least one reagent compound; at least one micro-channel reactor coupled in fluid communication with at least two of the plurality of reagent containers; and a reservoir in fluid communication with a last of the micro-channel reactor for storing an output produced by said micro-channel reactor. Still another form of the invention includes a second reservoir in fluid communication with the at least one micro-channel reactor for receiving and storing a by-product produced by the apparatus. In yet other forms, the combustion assembly may include a closed combustion chamber; a fuel inlet assembly attached to the closed combustion chamber; a plenum assembly disposed within the closed combustion chamber and attached to the fuel inlet assembly; a combustion pan assembly disposed within the closed combustion chamber, the combustion pan assembly including a plurality of protective angled sidewalls for directing energy in a predetermined direction within the closed combustion chamber; a plurality of fuel tubes interconnecting the plenum assembly to the combustion pan assembly; and an ignition assembly within the closed combustion chamber and proximate the combustion pan assembly on a side opposite the plenum assembly for igniting fuel within the combustion pan assembly.

In yet another form of the invention, a method is provided for powering a pneumatic motor, comprising the steps of reacting a plurality of ingredients to produce an explosive compound; conditioning the explosive compound to control a rate of explosive combustion; combusting the explosive compound in a closed container to produce a pressurized gas; storing the pressurized gas formed by the step of combusting in a storage vessel; and using the pressurized gas stored in the storage vessel to power the pneumatic motor. Modifications of the method include capturing ingredients that did not react in the reacting step; and recycling the ingredients that did not react to produce the explosive compound. Further forms include mixing a hydrocarbon based fuel with the explosive compound prior to the step of combusting. The step of transferring may include the step of passing the pressurized gas through a one-way valve to the storage vessel at the time of combusting the explosive compound in the closed container. Moreover the step of conditioning may include the step of diluting the explosive compound. The step of conditioning may include the step of stabilizing the explosive compound. Lastly the invention may include the step of collecting by-product and waste compounds produced by each of the steps and sequestering such by-product and waste compounds in a container and/or monitoring a change in pressure inside the closed container during the step of combusting and using such information to control the steps of reacting and conditioning.

The disadvantages of the prior art systems are solved by the present invention. Other advantages of the present invention may be better appreciated by referring to the following detailed description in combination with the drawing figures described below.

### BRIEF DESCRIPTION OF THE DRAWINGS FIGURES

FIG. 1 is a flow chart of the method used in association with the present invention;

FIG. 2 is a schematic diagram of a first embodiment of the present invention;

FIG. 3A is a schematic diagram a fuel module assembly shown in FIG. 2;

FIG. 3B is a schematic diagram of another embodiment of the assembly shown in FIG. 3A;

FIG. 4 is a schematic diagram of a micro-channel fuel reactor shown in FIG. 3A;

FIGS. 5A-5D show different views of a combustion chamber used in association with the invention;

FIG. 6 shows is an enlarged view of FIG. 5A;

FIG. 7 is a schematic diagram of a processor component shown in FIG. 3A;

FIG. 8 is a schematic diagram of a fuel reservoir shown in FIG. 3A;

FIG. 9 is a general schematic diagram of one embodiment of an electrical control system;

FIG. 10 is a schematic diagram of a reagent container used in association with the invention;

FIG. 11 is another embodiment of the air tank/pressure vessel labeled 6 in FIG. 2 and

FIG. 12 is yet another embodiment of the said pressure vessel.

### DETAILED DESCRIPTION OF THE DIFFERENT EMBODIMENTS

For purposes of description only, the terms “upper,” “lower,” “right,” “left,” “rear,” “front,” “vertical,” “horizontal,” and derivatives thereof shall relate to the invention as oriented in each of the respective figures. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Specific dimensions and other physical characteristics relating to the embodiments disclosed herein are not to be considered as limiting, unless the claims expressly state otherwise.

In its broadest form, the present invention comprises a method for locally producing an explosive compound and or stabilizing in real time within a small reactor assembly adjacent to a stationary power system or on board the vehicle using raw ingredients that may be carried on board the vehicle. The newly formed compounds from the reactor assembly are then introduced into a chamber where it is ignited and combusts under controlled conditions to produce a rapidly expanding gas. As the gas expands, substantial portions are bled off and stored in a pressure vessel. The pressure vessel in turn is connected to a pneumatic motor which is used to produce work such as drive the vehicle.

In another form of the invention, the explosive compound produced located by the reactor is made in many small parallel acting vessels so that it is not highly reactive. The output from the small parallel acting vessels is then conditioned with another compound to attenuate the rate at which the explosive compound combusts, yet high enough to produce a substantial and rapid expansion of gas to flow through conduits to the pressure vessel.

In yet another form of the invention, a pneumatic engine is in fluid communication with the pressure vessel. A valve controls the rate at which the pressurized gas within the vessel is released to the pneumatic motor to perform the necessary work. As the pressure in the pressure vessel drops, additional explosive compound is produced and combusted to replenish the pressure of gas within the vessel.

In yet another form of the invention, the gases discharged from the pressure vessel and used by the pneumatic motor are captured and recycled such that some of the raw compounds may be used again, there by allowing only the clean ones to be released to the atmosphere.

In another form of the invention, the method for generating a high pressure gas is used to power motors and applications whose working medium is expanding gases, including but not limited to pneumatic/compressed air engine and devices, external and internal combustion engines and gas turbines. These engines may be used by themselves or in combination with other engines. Through out this paper all the above mentioned machines will be referred to in general as a motor. It should be noted that this invention may be compatible with all manner of explosives including nitroglycerin, ammonium nitrate, trinitrotoluene, pentaerythritolteranitrate and any explosives known to those skilled in the field of explosives. However throughout this description, ammonium nitrate and nitroglycerin will be used to represent solid and liquid explosives respectively. Also due to the high efficiency of micro-channel reactors, it is most preferred that reactions be carried out using micro-channel reactor technology whenever possible. The inventive process comprises the steps outlined in the following paragraphs.

The invention comprises a method for pressurizing a fluid reservoir, comprising the steps of reacting raw components in a reaction chamber assembly to produce an explosive compound; diluting the explosive compound exiting the reaction chamber assembly; injecting the diluted explosive compound into a combustion chamber; igniting the diluted explosive compound in the combustion chamber causing the diluted explosive compound to produce a rapidly expanding gas; and venting the rapidly expanding gas to a pressure vessel connected to the combustion chamber through at least one one-way valve system. The method further comprises the steps of purifying the explosive compound from the raw components exiting the reaction chamber prior to the step of igniting. The method may further include the step of separately storing the raw components in individual containers adjacent the reaction chamber assembly. The step of reacting raw components comprises the step of passing the raw components through at least one micro-channel reactor.

In an alternate embodiment of the invention, a method is provided for powering a pneumatic motor, comprising reacting a plurality of ingredients to produce an explosive compound; conditioning the explosive compound to control a rate of explosive combustion; combusting the explosive compound in a closed container to produce a pressurized gas; transferring the pressurized gas formed in the closed container to a storage vessel; and using the pressurized gas stored in the storage vessel to power the pneumatic motor. Additionally the method comprising the steps of capturing ingredients that did not react in the reacting step; and recycling the ingredients that did not react to produce the explosive compound. The method may further comprise the step of mixing a hydrocarbon based fuel with the explosive compound prior to the step of combusting. The step of transferring may comprise the step of passing the pressurized gas through a one-way valve to the storage vessel at the time of combusting the explosive compound in the closed container while the step of conditioning may include the step of diluting the explosive compound. In addition, the step of conditioning may include the step of stabilizing the explosive compound. The method further contemplates the step of collecting by-product and waste compounds produced by each of the steps and sequestering such by-product and waste compounds in a container. In both forms of the invention, the method contemplates monitoring a change in pressure inside the closed container during the step of combusting and using such information to control the steps of reacting and conditioning.

The apparatus for pressurizing a fluid reservoir in accordance with the method comprises a fuel processor assembly; a combustion assembly having an inlet in fluid communication with said fuel processor assembly; an ignition assembly disposed within said combustion assembly; a pressure vessel assembly in fluid communication with an outlet of said combustion assembly via a conduit, said conduit including a valve assembly permitting flow of pressurized fluid in one direction from said combustion assembly to said storage container; and a pneumatically operated device in fluid communication with said pressure vessel through a metered conduit. The fuel processor assembly comprises a plurality of reagent containers each containing at least one reagent compound, at least one micro-channel reactor coupled in fluid communication with at least two of said plurality of reagent containers, and a reservoir in fluid communication with a last of said micro-channel reactor for storing an output produced by said micro-channel reactor. The apparatus may further include a second reservoir in fluid communication with the at least one micro-channel reactor for receiving and storing a by-product produced by the apparatus. The combustion assembly may be comprised of a closed combustion chamber, a fuel inlet assembly attached to the closed combustion chamber, a plenum assembly disposed within the closed combustion chamber and attached to the fuel inlet assembly, a combustion pan assembly disposed within the closed combustion chamber, the combustion pan assembly including a plurality of protective angled sidewalls for directing energy in a predetermined direction within said closed combustion chamber; a plurality of fuel tubes interconnecting the plenum assembly to said combustion pan assembly; and an ignition assembly within the closed combustion chamber and proximate the combustion pan assembly on a side opposite the plenum assembly for igniting fuel within the combustion pan assembly.

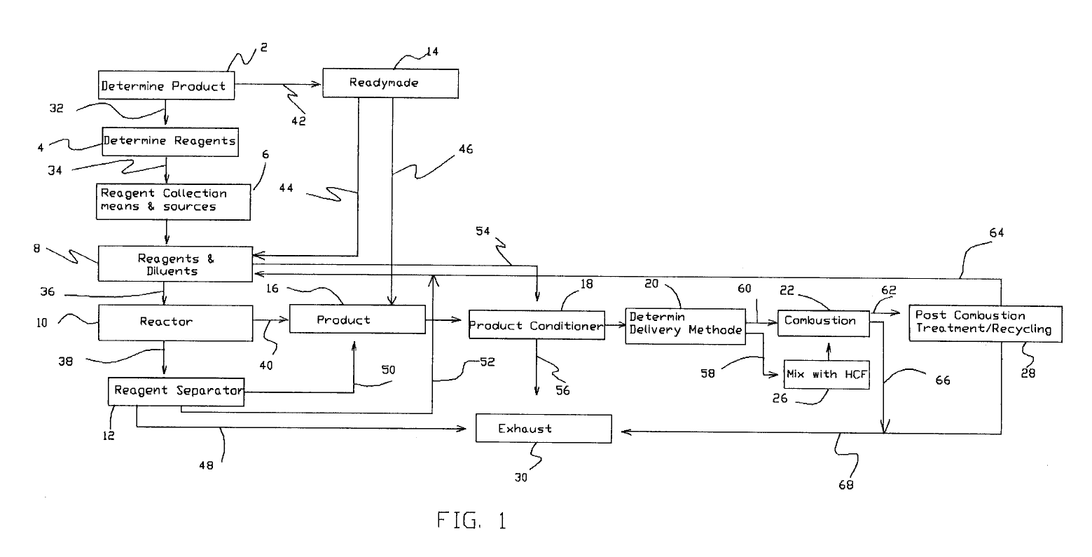

A better understanding of the inventive method and apparatus can be obtained by referencing the drawing figures, and particularly FIG. 1 which illustrates a flow chart generally outlining one embodiment of the method of the invention. Because FIG. 1 is general in nature, eliminating or rearranging some steps does not take away from the general spirit of the present invention.

Referring to FIG. 1, the method begins by determining/selecting (step 2) what fuel or explosive compound is needed. For the purposes of this description we will consider two compounds: Nitroglycerine and ammonium nitrate. If the compound is already manufactured or available off the shelf, the user can proceed directly to step 14 along decision line 42. If not, then the method proceeds along line 32 to the step of determining what reagents are necessary to form the compounds identified at step 4. In the case of making nitroglycerin, the list of reagents would include sulfuric acid, glycerin and nitric acid and diluents such as acetone, petroleum jelly or the like. At step 6 of the method, provision is also made to collect the raw materials and/or reagents to be used to form the product that was determined at step 2. In the case of Nitroglycerine, the means of collecting the reagents may include gas separators to collect and accumulate oxides of nitrogen and sulfur from the exhaust stream of a HCF combustion process. These gases are to be used in the formation of nitric and sulfuric acids which are among the reagents for nitroglycerin. Micro-channel reactors may be used at this stage to extract compounds like toluene from gasoline should the user deem it to be among the reagents needed. Another source is off-the-shelf compounds such as acetone which may be (or have been) identified at step 14.

If raw materials are to be used to produce the explosive compound, the method contemplates that the raw materials and reagents will be processed locally to produce sufficient quantities of the compound. This step in the method is designated by numeral 10 identifying a reactor. Suitable devices and structures for reacting the raw materials, reagents and compounds in a safe manner include one or more micro-channel reactors represented by numeral 10.

At step 8 the reagents and other compounds used in the process are sorted and stored. Some of the diluents are used later on in the process as indicated by arrow 54 while some are used in the reacting stage as indicated by arrow 36 along with the other raw materials and ingredients.

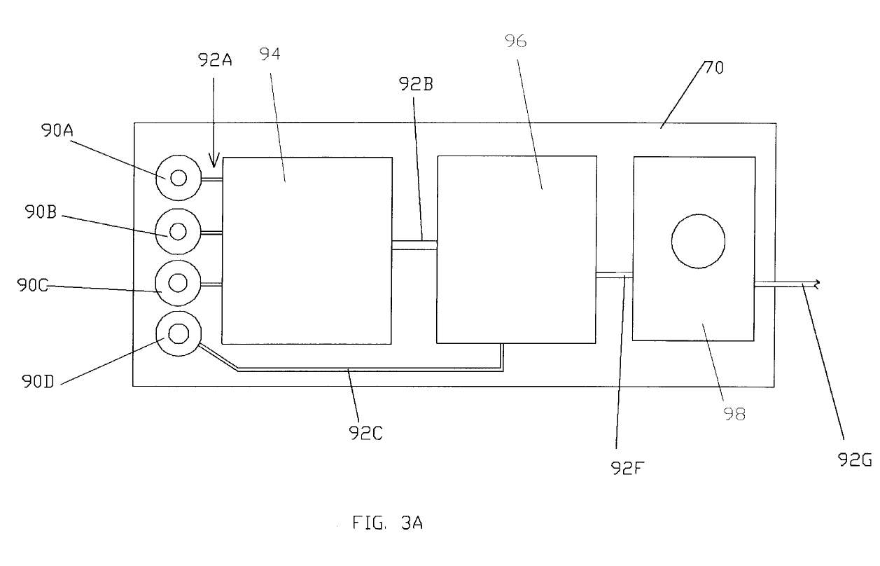

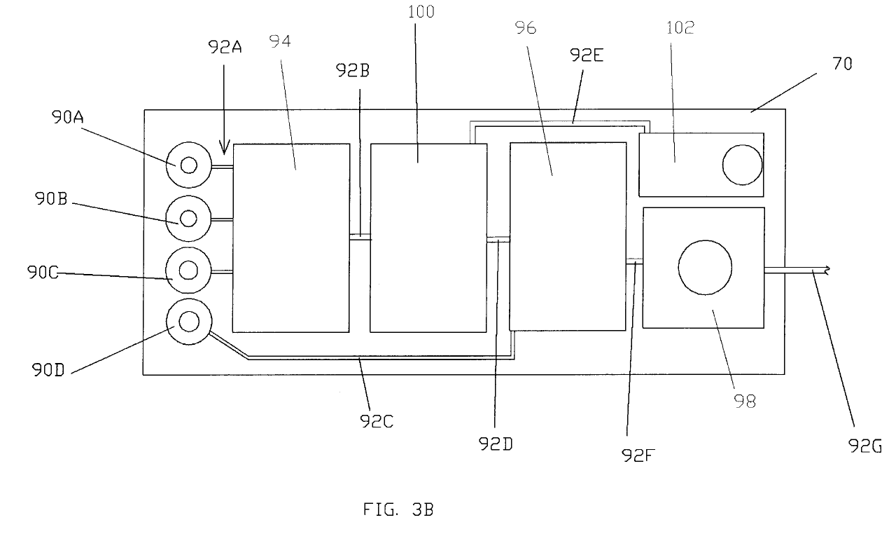

Represented by box 10 is the step where the raw materials, ingredients, and reagents are reacted to bring about the desired product. Depending on the efficiency of the reactors used the resulting product may be within acceptable limits of purity as represented by box 16. Once acceptable grade of explosive product is produced, it may be desirable to condition the product to make it more stable. But in most cases more than one product results. For example in the production of nitroglycerine in a batch reactor, the product of the reaction will include un-reacted acids, water and nitroglycerine. In the event product other than the explosive product are produced, the mixture is subject to a process where the un-used reagent, and water by-product are removed as illustrated by box 12, the output of which may be passed along line 50 to finished product represented by box 16. The step represented by box 12 is a purification step where the product is separated from the rest of the reactants. Here micro-channel reactors shown in FIGS. 3A and 3B are preferred because of their high efficiency. The unused reactants and by-products are exhausted as represented by box 30 via arrow 56 or captured for later use as represented by line 52.

In situations beginning with the step represented by box 14 and using already manufactured explosives, the present invention contemplates a new use for such products other than heretofore disclosed to the best of the inventor's knowledge. This is where a known composition of matter is used in a new way that it was not originally designed for. In certain circumstances, already manufactured products would be suitable and stored proximate the motor as represented by line 44. In other instances the ready made product represented by box 14 may need further refinement and/or reacting in order to make it suitable for the invention as represented by steps 10 and 12 before reaching an ideal stage at box 16. In other instances the pre-manufactured product is suitable and the user may move directly to step 16 along line 46.

At the step marked by box 16, the explosive product is substantially in a finished state. The desired product is substantially complete and at this point the user has an option of using the explosive product in accordance with the remainder of the invention. However in many instances it may be desired to perform another step of conditioning the product to control the rate of combustion or explosive force. As represented by the step at box 18, the explosive product phlegmatized and modified to match a predetermined set of characteristics best suited for combustion in a closed environment. For example if the product is too sensitive or unstable desensitizers like acetone and ethylene may be mixed with the nitroglycerine to stabilize the explosive it. It should be noted that the extent of dilution (amount of stabilizer added) is proportional to the difficulty of ignition. About ten percent to about thirty-five percent acetone may be used to stabilize the nitroglycerine substantially. Again depending on the efficiency of the reactors used to initially produce the nitroglycerine there may still be unwanted by-products. The conditioning step further serves to remove the by-products and disposes them along line 56 to step 30. For solid fuels like ammonium nitrate, at this step they may be ground to colloidal dimensions for transfer in an airstream. The ratio of ammonium nitrate to air (grams to liter respectively) determines the extent of attenuation. Otherwise other good phlegmatizers for nitroglycerin include petroleum jelly and mineral spirits as well as other compounds well known by those familiar with the field to which this invention pertains.

Box 20 represents the step where the means for delivering the explosive product to the closed combustion chamber is determined. The delivery mechanism or method may vary and may very well play a substantial role in retarding or attenuating the explosive combustion of the product. For example nitroglycerine may be delivered to the combustion chamber by multiple micro tubes depending on the sensitivity of the product as set by step 18. If the user decides on a substantially lower state of ignition (high sensitivity) then it can be safely delivered to the chamber via micro tubes to keep the product under critical mass. For ammonium nitrate as briefly mentioned above, it may be mixed with air and delivered to the combustion step 22 along line 60. However if the user desires a more powerful mixture the explosive product may be mixed with a hydrocarbon fuel such as gasoline or diesel fuel at step 26 along line 58. For example if ammonium nitrate is the explosive product in use, at step 26 a colloid thereof may be exposed to an atomized hydrocarbon fuel such as diesel to alter the combustion characteristics as will be readily apparent below. At this step the explosive product is mixed with the hydrocarbon fuel to bring about a mixture with substantially more power and effectiveness than it each were used independently. In a preferred embodiment of the invention, mixture ratio of ammonium nitrate to diesel may range from about 15.5:1 to as low as 3:1 depending upon the power desired. The user can vary the percentages until the mixture matches their desired conditions.

At step 22 the explosive product is combusted or detonated to produce a high pressure gas which is later used to operate an engine. Under some circumstances after the high pressure gas is used to power the motor, there is no need for post combustion treatment of exhaust products, e.g. embodiments that involve ammonium nitrate as the sole fuel, as its by-products are water, oxygen and nitrogen. These by-products may be vented directly to atmosphere as represented by line 66. In other circumstances such as the case with nitroglycerine is the sole fuel used to produce the high pressure gas, or where hydrocarbon fuels are mixed with explosive products to produce the high pressure gas, the by-products exhausted by the motor may be captured and cleaned as represented by step 28 along line 62.

Step 28 represents a stage where separators may be used to scrub valuable reagents like oxides of nitrogen and sulfur are recaptured. Capture of the exhaust by-products at this step would be helpful if the user determines the exhaust gas contains sufficient reagent sources. In such case the by-products are added to the raw materials described earlier along line 64 otherwise they are released to the atmosphere along line 68. Under some conditions, the present invention allows for exhaust products to be cooled and contained in a tank before being released in the atmosphere. This provides an opportunity for various cheaper and slow separation techniques like fractional distillation to be applied.

### EXAMPLE 1

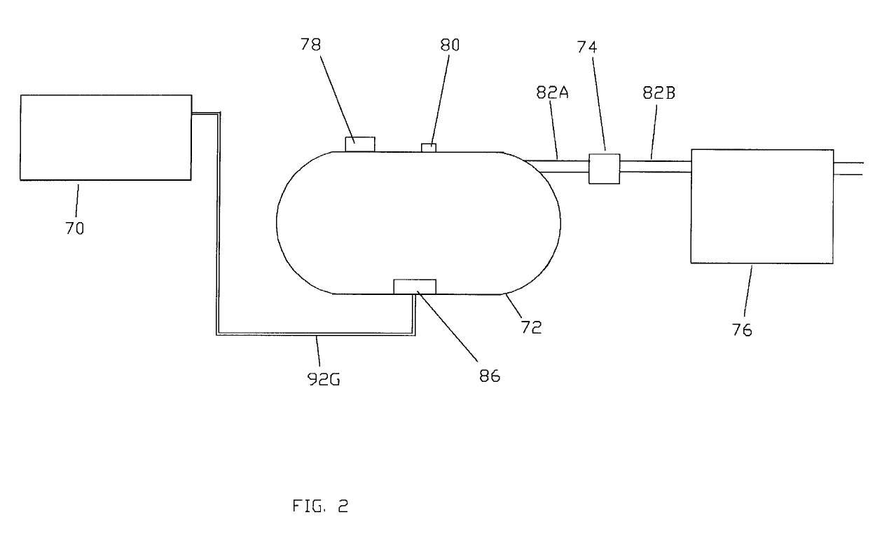

The following is a first example of the invention where nitroglycerine is the desired product. Nitroglycerine (NG) is selected as the fuel in step 2 of FIG. 1. In this embodiment NG is detonated inside an air tank of a pneumatic engine. Examples of technologies that benefit from this embodiment include the compressed air car, Pneumatic engine, and the PHEV (pneumatic hybrid electric vehicle) among others. FIG. 2 schematic illustrates an apparatus that may be used to carry out this method of the invention. A fuel processor module represented by reference numeral 70 is connected to the combustion or detonation device 86 by one or more tubes identified by reference 3G. The detonation device 86 is located inside the air tank 72. The air tank 72, which may also be referred to as an expansion chamber or pressure vessel, is connected to a valve 74 by air duct 82A. Valve 74 in turn is connected to air duct 82B and this in turn is connected to a pneumatic device 76 such as a motor. Also shown in the figure is an emergency relieve valve 78 and a pressure sensor 80 for controlling the amount of pressure present within the expansion or combustion chamber at any given instant in time.

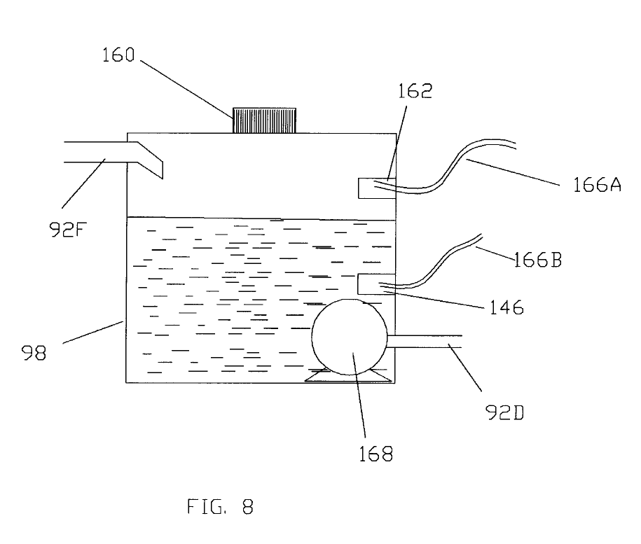

FIG. 3A shows a more detailed schematic view of the fuel processor module 70 and also depicts one possible arrangement of the components therein. In one embodiment the fuel processor module is comprised of three main components: a plurality of reagent containers 90A through 90D, a reservoir 98 and at least one, and preferably two micro-channel processor or reactor stacks 94 and 96. Note that only one layer (reactor stacks 94 and 96 and connecting tubes 92A, 92B, 92C) is shown for each stack. All containers and both reservoirs have closeable openings for adding reagents/liquids from the outside. Numerals 92A through 92G represent the lines or conduits interconnecting the different components. Lines 92A connect each of the containers 90A, 90B and 90C to micro-channel reactor 1. Container 90D is connected by line or conduit 92C to micro-channel reactor 96. The reagent containers 90A-90D may be equipped with pumps (not shown) which may supply the reagents to the micro-channel reactors 94 and 96 at preset pressure ratios to allow correct reagent ratios, i.e. fifty-percent sulfuric acid, forty-percent nitric acid and ten percent glycerin. Micro-channel reactor or processor 1 may be connected to micro-channel reactor or processor 96 by line or tube 92B. Micro-channel processor 96 may then be connected to a fuel reservoir 98 by tube 92F. The fuel reservoir may be equipped with a pump (shown in FIG. 8), which is connected to output line 92G. The user may decide to employ one or more booster pumps after each stack to pass the product to the next assembly. Also it may be easier to regulate mixture ratios by using restrictor valves on every reagent container outlet.

### EXAMPLE 2

Referring now to FIG. 3B, the fuel processor module 70 may have an extra stack of micro-channel reactors arranged in series. According to the method at box 8 in FIG. 1, where the efficiency of a single micro-channel reactor such as represented by numeral 1 is less than 100% and un-reacted reagents and/or compounds are produced, (follow line 36) a second micro-channel reactor or processor such as represented by numeral 100 may be used to purify the newly formed explosive product. The main components of the fuel processor module 70 include containers 90A through 90D, a reservoir 98, a removable reservoir 102, and micro-channel reactor or processors stacks 94, 96 and 100. Note that only one layer (reactor layer and connecting tube) is shown for each stack. Numerals 92A through 92G represent the paths of the reagents and compounds within containers 90A, 90B and 90C respectively pass through to micro-channel reactor 94. Container 90D may be connected to micro-channel reactor or processor 96 by tube 92C. The reagent containers may be equipped with pumps (not shown) to maintain or supplement system pressure to allow correct reagent ratios, i.e. fifty-percent sulfuric acid, forty-percent nitric acid and ten-percent glycerin. Micro-channel processor 94 may in turn be connected to micro-channel processor 100 by one or more tubes identified by numeral 92B. Micro-channel processor 100 may have two outlets: one outlet connected via line 92E to reservoir 102, and another outlet connected via line 92D to an input side of micro-channel processor 96. Micro-channel processor 96 may be connected to fuel reservoir 98 by tube 92F. The fuel reservoir may be equipped with a fluid pump (shown in FIG. 8), which is connected to output tube 92G. If the user decides booster pumps can be put after each stack. Also it may be easier to regulate mixture ratios by using restrictor valves on every reagent container outlet.

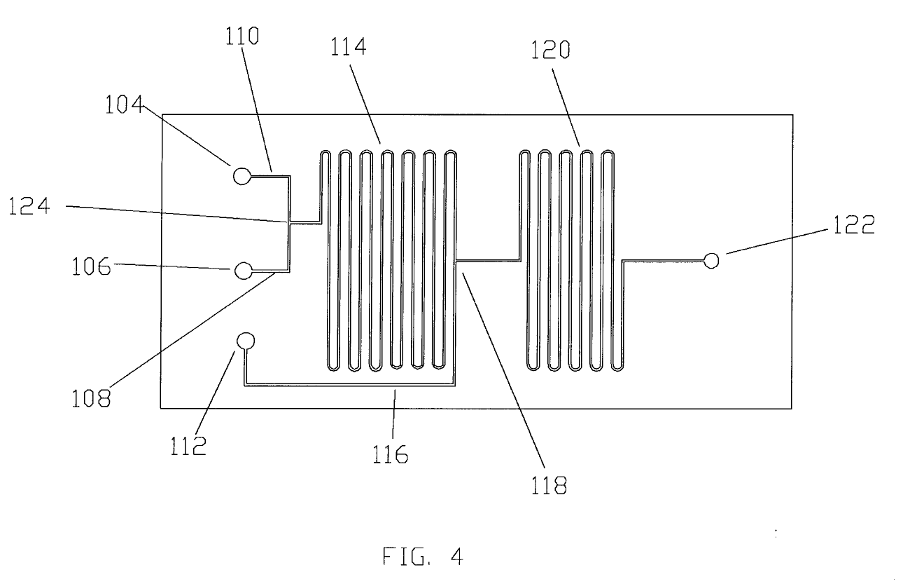

FIG. 4 is a more detailed schematic diagram of one embodiment of a micro-channel reactor or processor such as described above. Since each bank of reactors may include substantially identical micro-channel reactors, only one reactor is shown and will be described herein. The channels or lines identified by numerals 108, 110 and 116 begin at input ports 104, 106 and 112, respectively. Channel 108 and 110 may be joined at junction 124 to form sinuous channel 114. Channel 114 may in turn join channel 116 at junction 118 to form channel 120 which terminates at output 122. Channels 114 and 120 run in a sinuous fashion to provide greater surface area for temperature control which is believed to be important in the reaction of certain compounds.

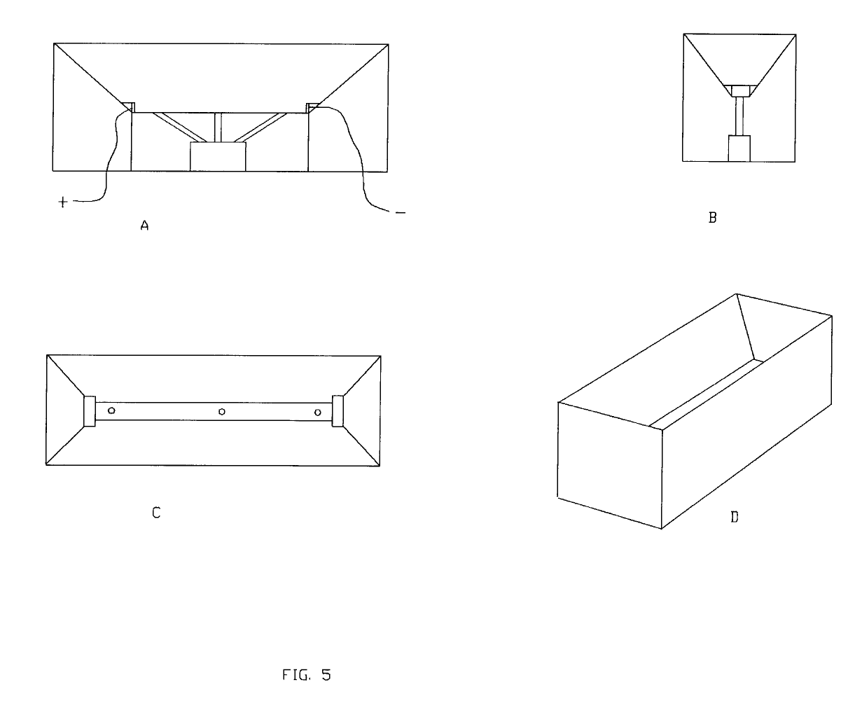

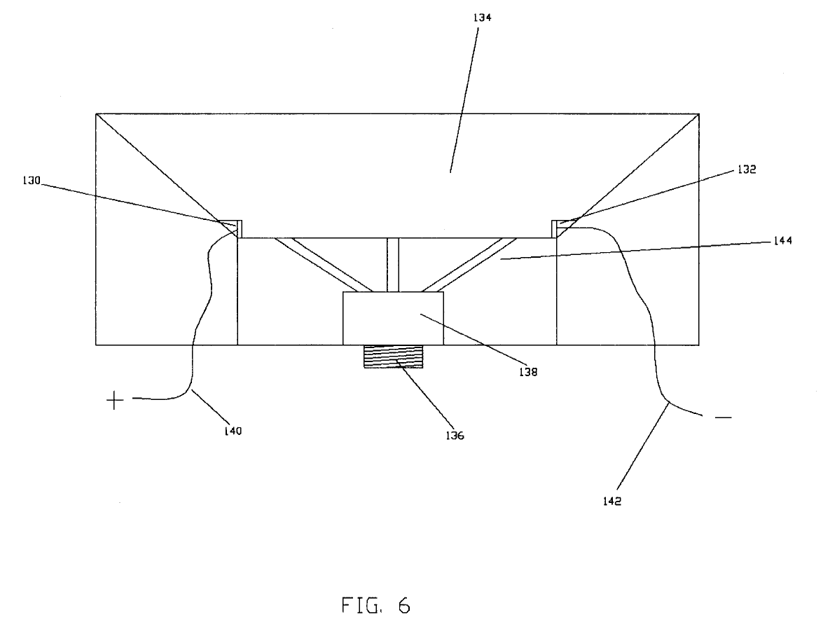

FIGS. 5A-5D show various views of one embodiment of a combustor 86 used inside the air tank 72 described above. FIG. 5A shows a front view of the combustor, FIG. 4B shows a side view and FIG. 5C shows a top or plan view. As depicted the combustor 86 is generally trough shaped vessel which is encased within the closed combustion chamber identified by numeral 72 in FIG. 2. Note that the plurality of openings or holes formed in the bottom of the trough-shaped structure which are attached to micro tubes extending from the under side of the trough-shaped structure. FIG. 4D illustrates a perspective view of the combustor 86. Also not the protective side walls at the lower side of the combustor. FIG. 6 is a more detailed depiction of the combustor 86 shown in FIG. 4A including a threaded nipple 136 which is attached to a small chamber 138 which extends through the bottom of the closed combustion chamber 86 shown in FIG. 2. The small chamber 138 in turn is connected to a plurality of micro-tubes 144. The collection of micro-tubes terminates in the bottom of the trough-shaped combustor 86 described briefly earlier. Also shown are an anode 130 and cathode 132 to which terminals 140 and 142 are attached and connected to a source of electricity. As NG is introduced through nipple 136, it flows through micro-tubes 144 and eventually flows into the bottom part of the trough-shaped structure forming combustor 134 creating contact with the two electrodes. When the proper voltage is applied to conductors 140 and 142, the NG is detonated.

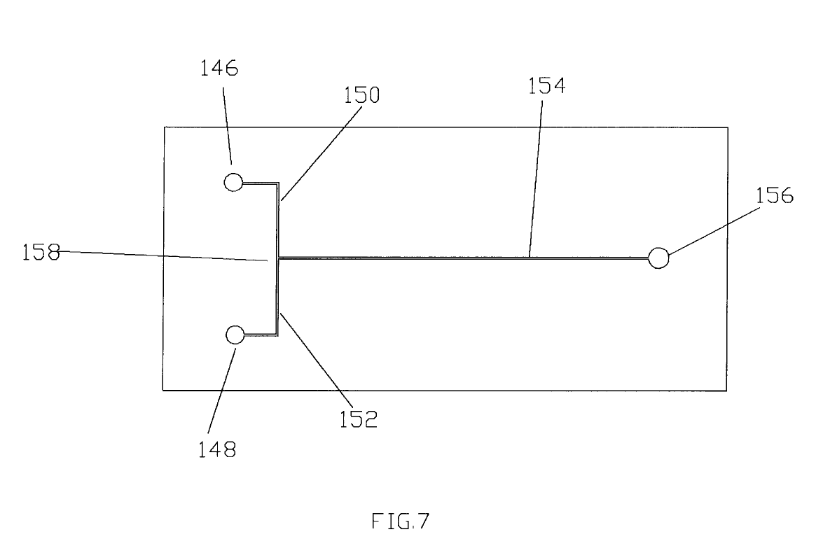

FIG. 7 shows another embodiment of a micro-channel processor or reactor that may be found in reactor stack 96 described earlier. Included are two inputs 148and 148 connected to channels 150 and 152, respectively which join at junction 158 to form channel 154. Channel 154 ends at out put 156. The length of channel 154 may be adjusted to provide increased exposure time for the product depending upon the desired results.

FIG. 8 is a schematic cross-sectional view of a one embodiment of a fuel reservoir 98 contemplated to be used in association with the invention. Stabilized NG flows in to reservoir 98 through input tube 92F extending from the reactor 96 described above. FIG. 8 also shows upper and lower level sensors 162 and 146 respectively which communicate with a remote electronic control module (ECM) through conductor wires 166A and 166B. An output tube 92D is connected to a fuel pump 168 disposed in the bottom of the fuel reservoir. The fuel reservoir 98 may also have a fill cap or inspection plate which provides the option of adding fuel should a need to do so arise.

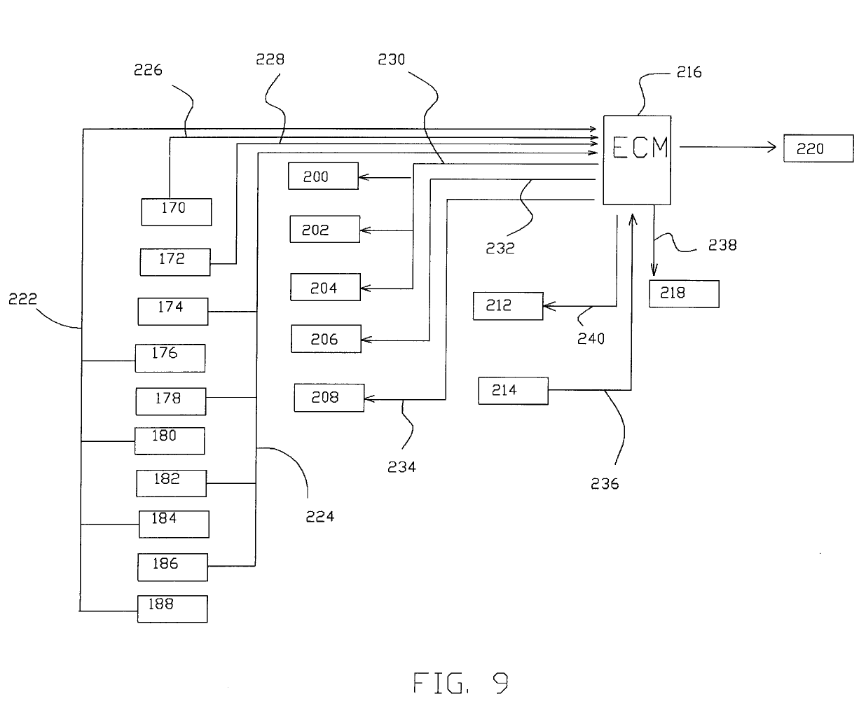

FIG. 9 is a basic schematic diagram for the electronic control system mentioned above. Boxes 200 through 210 represent electric pumps which are controlled by the ECM by turning power on or off. Boxes identified by numerals 200, 202, 204 and 206 represent pumps attached to each of the containers containing reagents, ingredients or other compounds used in the manufacture of the explosive product and briefly mentioned above. Item 208 represents the fuel pump 98 described above. Boxes 170 through 188 represent fluid level sensors. Sensors 170 and 172 are disposed within fuel tank, sensors 174 and 176 are disposed in the container 90A, sensors 178 and 180 for container 90B, sensors 182 and 184 for container 90C, and sensors 186 and 188 for container 90D. Item 60 in the schematic represents an emergency pressure release valve attached to the closed combustion chamber 6, item 74 is an air tank pressure sensor attached to the pressure vessel, item 218 represents the electrodes in the combustor 86, and item 220 represents a visual display (for monitoring purposes) for a user. Lines 222 and 226 send a “Liquid Full” signal to controller 216 while lines 224 and 228 send a “Liquid Low” signal to the controller 216. Lines 230, 232 and 234 are “Power On/Off” lines for pumps associated with the containers 90A-90D. Line 240 is Power On/Off for the emergency relieve valve while line 238 is “Power On/Off” for combustor 86. Line 236 sends the signals “Minimum and Maximum Pressure” to controller 216. Box 212 represents emergency relieve valve 78, box 214 represents the pressure sensor 80 and box 218 represents combustor 86.

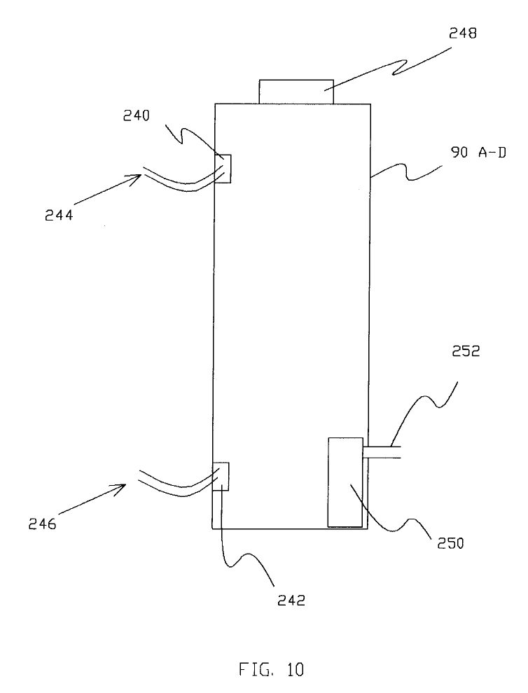

FIG. 10 is a schematic representation of one embodiment of the reagent containers described earlier by reference numerals 90A-90D. Each container includes cap 248. Disposed within each container is an upper level sensor 240 and a lower level sensor 242. Disposed in the bottom of each container is a pump 250 connected to the outlet line 252.

### Operation

The invention operates in two broadly defined ways. According to one method it allows an onboard fuel production process which may be used alone or it may be used to conjunction with another system to supplement the power/energy generating processes. In an alternate method the invention operates to stabilize or attenuate the normally highly rate of expansion of combustion of explosive compounds for use in engines. In one embodiment a predetermined amount of NG is used to provide instantly high pressure gases which are used to operate an engine. It has been reported that the volume of gaseous products produced by the detonation of nitroglycerine is generally equal to about 10,000 times its original volume. Using that data it becomes clear that a very small amount of NG can to produce a large volume of pressurized gases, whose pressure can be used to operate various engines as described above. The reaction products of NG are relatively clean and include N₂, O₂, H₂O and CO₂. The operator uses control valve 72 of FIG. 2 as a throttle to control the pressure amount released to the pneumatic engine. Whenever the pressure of the gas in the pressure vessel falls below a predetermined threshold, pressure sensor 80 sends a signal to the ECM which sends a signal to the fuel reservoir pump to pump more NG to the combustion chamber 86 where it is ignited to increase the pressure in side the pressure vessel. The rate of detonation is only as much as necessary to produce the maximum pressure of reaction products that the pressure vessel is designed to withstand and the frequency of detonations is determined by the ECM accordingly. The ECM is constantly monitoring the pressure readings from the pressure sensor 80 and maintains the air tank pressure within acceptable limits in the following steps; pressure too low =ignite more fuel; pressure normal=end ignition of fuel; pressure above threshold=open pressure relive valve. In reference to FIG. 3B, fuel processor 70 is like an onsite NG production facility. Nitric acid, glycerin and sulfuric acid are contained within their respective reagent containers equipped with pumps. The reagents are pumped into the micro-channel reactor 94 which allows the reagents to react, producing a mixture of nitroglycerin, and small amounts of water and un-reacted acids. This mixture is injected into micro-channel reactor 100 for purification and the impurities are piped to reservoir 102 for either recycling or proper disposal as user may see fit. The resulting explosive product (NG) is directed to reactor 96 for desensitization.

In reference to FIG. 7, the operation of reactor 96 is hereby explained. NG from reactor 100 is injected into port 146 and a diluent like acetone from reagent container 90D is injected through port 148. The two intermix as they flow through channel 154. By the time the explosive product reaches exit port 156 it is desensitized and directed to reservoir 102 through tube 92F. If the pressure in the pressure vessel storing the pressurized gas falls below a predetermined value, ECM turns on the pump 168 in the fuel reservoir 98 to pump NG to the detonation chamber 86. As the NG level falls, eventually level sensor 146 sends a signal to ECM through wires 166B which in turn sends a signal to the reagent pumps 90A to 90D to make more fuel which flows through tube 92F. As the level rises, it eventually reaches sensor 162 which sends a signal to ECM through wires 166A and the ECM turns off the reagent pumps.

In another embodiment, the desensitized explosive is detonated inside a combustion chamber hence IC (internal combustion) just after top dead center of the piston. Again a predetermined amount of the explosive product is ignited inside a chamber and used in the same way a conventional hydrocarbon based fuel such as gasoline or diesel are used in prior art. Upon ignition, the amount of explosive product used may yield at least 550 pounds per square inch which is the average minimum for internal combustion engines. In another embodiment the desensitized explosive is used to run a gas turbine. In another embodiment the explosive is used as a fuel additive.

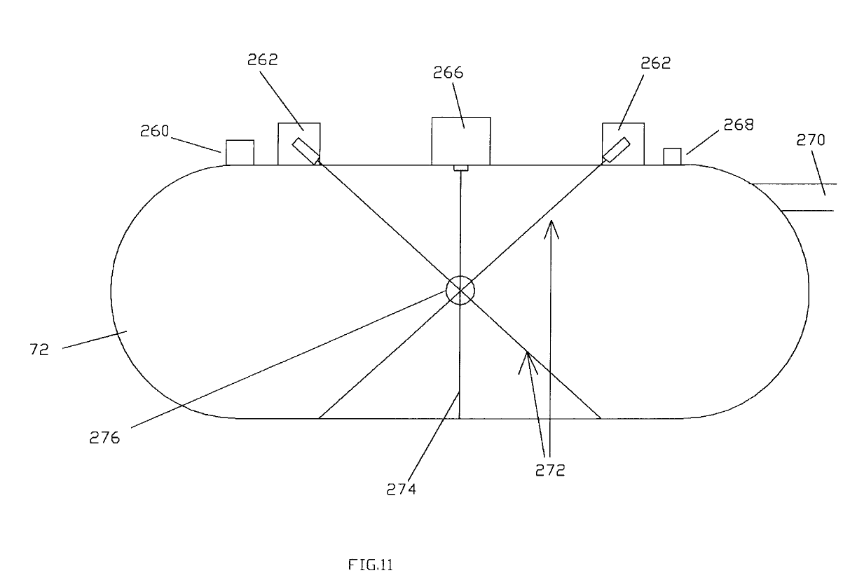

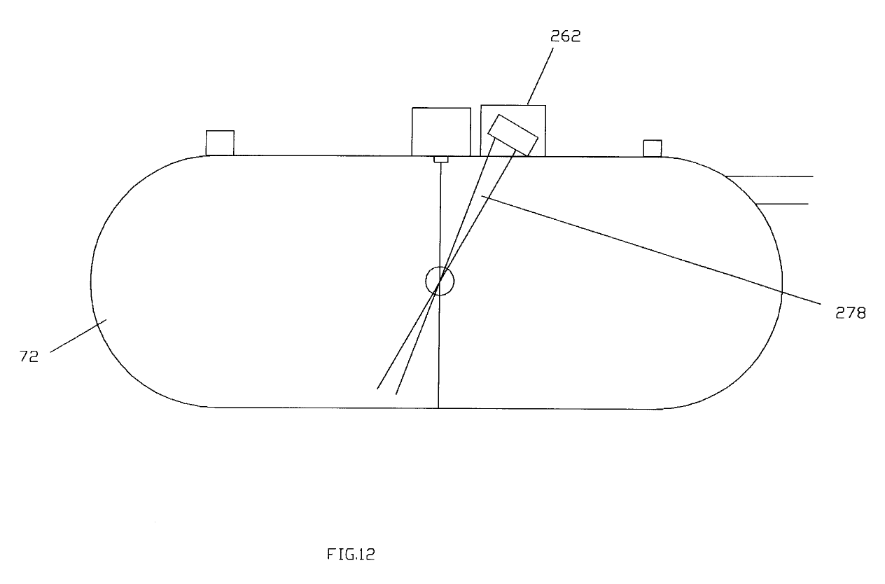

FIG. 11 illustrates an alternate embodiment of the air tank/pressure vessel 72 briefly described above. The exemplary combustion chamber 86 of the first embodiment may suffer low durability due to the high power of explosives. This alternate embodiment addresses that problem by eliminating chamber 86 and the air tank/vessel itself in a way becoming the combustion chamber. The energetic material/fuel may be remotely ignited inside the air tank while in motion (The phrase “while in motion” in this paper in reference to fuel, is the period after insertion or injection, while in mid air, or during free fall). The ignition may be achieved by any means of directed energy including microwave but more preferably laser. A laser beam represented by lines 272 is calibrated to intersect the trajectory of the fuel, which is represented by line 274. The inside walls of the tank may be protected from the damaging effects of the laser by concentrating or confining the directed energy in a small space inside the vessel. This space, referred to as the Detonation Zone or DZ is the zone where the path of the energy and the trajectory of the fuel intersect. It is generally represented by circle 276 in FIG. 11 and 12. As the fuel is ignited, detonation takes place in DZ, without physical contact to anything except the gases inside the tank thereby minimizing the damage to the tank/vessel. The confinement or concentration of energy may be achieved many ways including by using a plurality of beams of energy converging in the same area as shown in FIG. 11. In this case the energy of individual beams may be below a level that will damage the tank walls. It should be noted that whenever multiple beams are used in accordance with the present invention, great care should be taken to prevent their waves from canceling each other out. This may be done by using beams of slightly different wave lengths. Alternatively ignition may occur by focusing a laser at a focal point calibrated to be in the detonation zone as illustrated in FIG. 12 (this figure is shown with only the new parts labeled). The location of the DZ can be anywhere inside the tank but in order to minimize the above mentioned problems, it is preferred that it be located toward the center of the tank. In the case of an irregular or non spherical tank, the location of the DZ should be at the average farthest point away from the interior walls. If the energy is focused, then the focal point should be positioned on the axis of the said trajectory.

In yet another embodiment, pressure vessel 72 plays a power assist role to another pressure vessel where the two vessels are in fluid communication via a connecting tube. The tube may be fitted with a one way valve permitting the gases to flow only in one direction exiting the combustion chamber. The threshold value for the valve in the connecting tube is set to a pressure which is greater than the current pressure present in the pressure vessel, but below the burst pressure of the pressure vessel so that the expanding gases can move from the present vessel to the other pressure vessel.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents. The embodiments of the invention in which an exclusive property or privilege is claimed are defined below.

Having now described the features, discoveries and principles of the invention, the manner in which the invention is constructed and operated, the characteristics of the invention, and the advantageous, new and useful results obtained; the new and useful structures, devices, elements, arrangements, parts and combinations are set forth in the appended claims.

I claim as my invention:

1. A method for pressurizing a fluid reservoir, comprising the steps of:
a) reacting raw components in a reaction chamber assembly to produce an explosive compound;
b) diluting the explosive compound exiting the reaction chamber assembly;
c) injecting the diluted explosive compound into a combustion chamber;
d) igniting the diluted explosive compound in the combustion chamber causing the diluted explosive compound to produce a rapidly expanding gas; and
e) venting the rapidly expanding gas to a pressure vessel connected to the combustion chamber through at least one one-way valve system.

2. The method for pressurizing a fluid reservoir as defined in claim 1, further comprising the steps of purifying the explosive compound from the raw components exiting the reaction chamber prior to the step of igniting.

3. The method for pressurizing a fluid reservoir as defined in claim 1, further comprising the step of separately storing the raw components in individual containers adjacent the reaction chamber assembly.

4. The method for pressurizing a fluid reservoir as defined in claim 1, wherein the step of reacting raw components comprises the step of passing the raw components through at least one micro-channel reactor.

5. An apparatus for pressurizing a fluid reservoir, comprising:
a) a fuel processor assembly;
b) a combustion assembly having an inlet in fluid communication with said fuel processor assembly;
c) an ignition assembly disposed within said combustion assembly;
d) a pressure vessel assembly in fluid communication with an outlet of said combustion assembly via a conduit, said conduit including a valve assembly permitting flow of pressurized fluid in one direction from said combustion assembly to said storage container; and
e) a pneumatically operated device in fluid communication with said pressure vessel through a metered conduit.

6. The apparatus as defined in claim 5, wherein said fuel processor assembly comprises:
a) a plurality of reagent containers each containing at least one reagent compound;
b) at least one micro-channel reactor coupled in fluid communication with at least two of said plurality of reagent containers; and
c) a reservoir in fluid communication with a last of said micro-channel reactor for storing an output produced by said micro-channel reactor.

7. The apparatus as defined in claim 6, further comprising a second reservoir in fluid communication with said at least one micro-channel reactor for receiving and storing a by-product produced by the apparatus.

8. The apparatus as defined in claim 6, wherein said combustion assembly comprises:
a) a closed combustion chamber;
b) a fuel inlet assembly attached to said closed combustion chamber;
b) a plenum assembly disposed within said closed combustion chamber and attached to said fuel inlet assembly;
d) a combustion pan assembly disposed within said closed combustion chamber, said combustion pan assembly including a plurality of protective angled sidewalls for directing energy in a predetermined direction within said closed combustion chamber;
e) a plurality of fuel tubes interconnecting said plenum assembly to said combustion pan assembly; and
f) an ignition assembly within said closed combustion chamber and proximate said combustion pan assembly on a side opposite said plenum assembly for igniting fuel within said combustion pan assembly.

9. A method for powering a pneumatic motor, comprising:
a) reacting a plurality of ingredients to produce an explosive compound;
b) conditioning the explosive compound to control a rate of explosive combustion;
c) combusting the explosive compound in a closed container to produce a pressurized gas;
d) transferring the pressurized gas formed in the closed container to a storage vessel; and
e) using the pressurized gas stored in the storage vessel to power the pneumatic motor.

10. The method as defined by claim 9, further comprising the steps of:
a) capturing ingredients that did not react in the reacting step; and
b) recycling the ingredients that did not react to produce the explosive compound.

11. The method as defined by claim 9, further comprising the step of mixing a hydrocarbon based fuel with the explosive compound prior to the step of combusting.

12. The method as defined by claim 9, wherein the step of transferring comprises the step of passing the pressurized gas through a one-way valve to the storage vessel at the time of combusting the explosive compound in the closed container.

13. The method as defined by claim 9, wherein the step of conditioning includes the step of diluting the explosive compound.

14. The method as defined in claim 9, wherein the step of conditioning includes the step of stabilizing the explosive compound.

15. The method as defined in claim 9, further comprising the step of collecting by-product and waste compounds produced by each of the steps and sequestering such by-product and waste compounds in a container.

16. The method as defined in claim 9, further comprising the step of monitoring a change in pressure inside the closed container during the step of combusting and using such information to control the steps of reacting and conditioning.
